(19) United States
(12) Patent Application Publication
(10) Pub. No.: US 2013/0266135 A1
(43) Pub. Date: Oct. 10, 2013

(54) System for DNA Identification Hiding Personal Traits

(71) Applicant: Douglas Charles Pratt, Downingtown, PA (US)

(72) Inventor: Douglas Charles Pratt, Downingtown, PA (US)

(73) Assignee: SIEMENS MEDICAL SOLUTIONS USA, INC., Malvern, PA (US)

(21) Appl. No.: 13/473,651

(22) Filed: May 17, 2012

Related U.S. Application Data
(60) Provisional application No. 61/619,984, filed on Apr. 4, 2012.

(51) Int. Cl. G06F 21/24

(52) U.S. Cl. 380/28

(57) ABSTRACT

A system for DNA sequence identification hides personal and medical characteristics. A DNA sequencer processes a biological sample to provide genetic data identifying biological sample genetic marker variations of multiple different markers from corresponding reference markers. An encoding processor one way encrypts the genetic data into an encrypted code using an encryption key. A comparator compares the encrypted code with multiple encrypted codes retrieved from storage to identify a match and biological sample source. The multiple encrypted codes are derived by encrypting genetic data of multiple different biological samples using the encryption key and the multiple different biological samples are associated with corresponding identifiers of their respective biological sample sources.

This is a non-provisional application of provisional application Ser. No. 61/619,984 filed Apr. 4, 2012, by D. C. Pratt.

### FIELD OF THE INVENTION

This invention concerns a system for DNA sequence identification hiding personal and medical characteristics by one way encrypting genetic data into an encrypted code using an encryption key.

### BACKGROUND OF THE INVENTION

It is increasingly common for an unidentified DNA sample to be collected (e.g., at a crime scene) and matched against samples of a population of individuals. An agency (e.g., law enforcement) may wish to collect and sequence DNA samples of the population to match or exclude individuals within that population. However, members of that population may be reluctant to contribute samples because of the possibility that intimate and potentially embarrassing and damaging medical condition related information can be derived from genetic data. Sensitive medical conditions include a propensity for mental illness, alcoholism, chronic and expensive diseases, and a myriad of other conditions. A number of issues are raised by the acquisition of this information including, privacy, data protection, civil rights and workplace issues where employers, specifically police departments, for example, have controversially attempted to require officers to donate DNA samples to be sequenced and filed in a database. These issues are substantially reduced if there are safeguards in place to prevent sensitive medical information from being revealed.

Known systems typically store DNA sequences in their native insecure format such that medical information is derivable from the stored sequences. Further, as the DNA information is digital in form, it is readily copied, leaked, and posted on public servers. The insecurity is exacerbated by the spread and ready availability of sequencing technology as it becomes less costly and more advanced. In addition to exposing individuals that volunteer samples to risk of breach of their privacy, the insecurity discourages others from submitting samples for identity purposes, inhibiting investigations. A system according to invention principles addresses providing privacy safeguards and preventing human access to sensitive DNA sequence information.

### SUMMARY OF THE INVENTION

A system creates unique personal identifiers from DNA level variants of a human individual within genetic markers and the personal identifiers advantageously provide no personal, health-related biological information. A system for DNA sequence identification hides personal and medical characteristics. A DNA sequencer processes a biological sample to provide genetic data identifying biological sample genetic marker variations of multiple different markers from corresponding reference markers. An encoding processor one way encrypts the genetic data into an encrypted code using an encryption key. A comparator compares the encrypted code with multiple encrypted codes retrieved from storage to identify a match and biological sample source. The multiple encrypted codes are derived by encrypting genetic data of multiple different biological samples using the encryption key and the multiple different biological samples are associated with corresponding identifiers of their respective biological sample sources.

### BRIEF DESCRIPTION OF THE DRAWING

FIG. 1 shows a system for DNA sequence identification that hides personal and medical characteristics, according to invention principles.

FIG. 2 shows a table presenting a known unencrypted DNA sequence from an individual.

FIG. 3 shows a flowchart of a process performed by the system for DNA sequence identification that hides personal and medical characteristics, according to invention principles.

### DETAILED DESCRIPTION OF THE INVENTION

A system creates unique personal identifiers from DNA level variants of a human individual within genetic markers. Advantageously, no personal, health-related biological information is inferable from the personal identifiers. The system enables a population to contribute DNA samples for purposes of establishing identity in a secure manner and also enables determining or excluding a DNA match of an acquired sample with individual samples of a pre-sequenced database of samples. The system enables entities to take advantage of the uniqueness properties of DNA level variants within genetic markers while overcoming reluctance to store personal biological information.

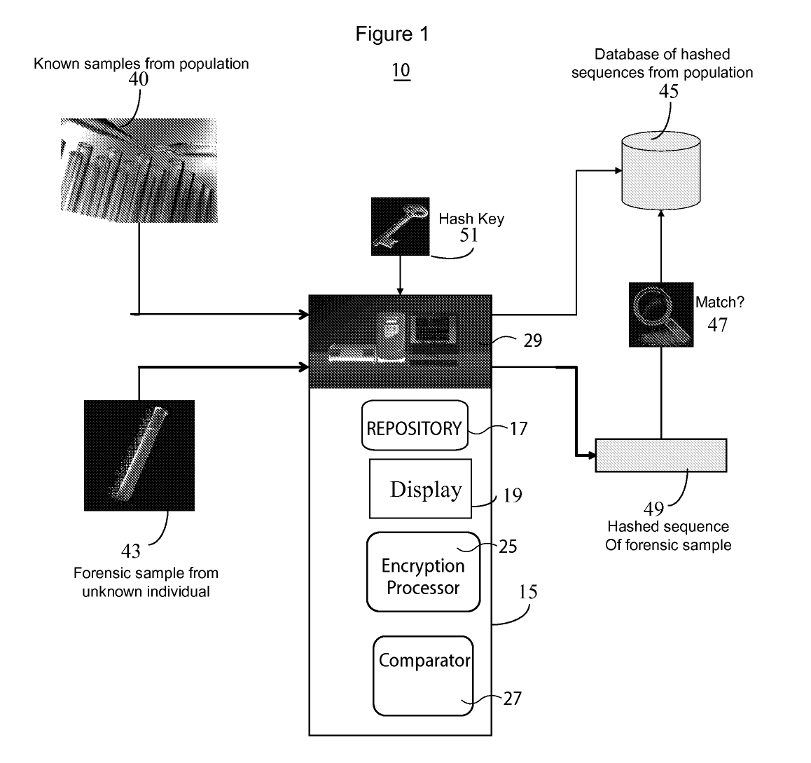

FIG. 1 shows system 10 for DNA sequence identification that hides personal and medical characteristics. System 10 includes one or more processing devices 15 comprising a DNA sequencing machine 29, display 19, encryption processor 25, at least one repository 17 and comparator 27. Display 19 includes a Graphical User Interface (GUI) enabling user interaction with the system. DNA sequencer 29 processes biological sample 43 from an individual to provide genetic data identifying biological sample genetic marker variations of a plurality of different markers from corresponding reference markers. Encoding processor 25 performs one way encryption (e.g. by hashing) of the genetic data into an encrypted (hashed) code 49 using encryption key 51. Comparator 27 compares the encrypted code 49 with multiple encrypted codes of a population retrieved from storage in database 45 to identify a match 47 and biological sample source. The multiple encrypted codes are derived by processor 25 using key 51 in encrypting genetic data of a population and by storing the encrypted genetic data in database 45. The genetic data of the population is retrieved from database 40 and is provided by sequencing different biological samples of the population and the different biological samples are associated with corresponding identifiers of their respective biological sample sources (individual people). Any of the units of system 10 may be located in one or more of the units of system 10 and may be distributed among different units of system 10 or be located in sequencer 29. At least one repository of information 17 includes different encryption codes used by different sequencing machines, databases, institutions, organizations or other entities.

In one embodiment, system 10 applies a secure, 1-way hashing function to DNA level variants within genetic markers resulting in a value that uniquely identifies an individual person, but from which no personal health information can be inferred. The function is applied directly by sequencing machine 29 in such a way that original DNA level variants within genetic markers are not committed to storage nor divulged to a machine operator, ensuring protection of personal health information. System 10 generates an identifier based on DNA level variants within genetic markers of an individual within a population. The identifier is used to determine a probable match to a DNA sample in a database or to exclude a match, while masking personal health information.

DNA identification information is useful for biometric identification and for system generation of an organization database of identifiers of individuals. The system is usable in an access control device with an onboard DNA sequencer to process a biological sample to confirm identity in a healthcare setting, for example. The system advantageously provides individuals with confidence that their biological information may not be inferred or derived and hence are more likely to volunteer a DNA sample and agree to have it stored in a Health Information System. If an individual arrives at a hospital in an unconscious state, the identity of the individual can be ascertained and hence critical data about allergies, medications and health conditions may be automatically determined. In addition, donated organs and other tissue may be positively identified.

The system advantageously enables personal health information to be rendered undeterminable whilst retaining the unique identification qualities of DNA sequencing. In one embodiment, the system function is advantageously embedded within a DNA sequencing machine without storing an original DNA sequence within the machine, excluding access to the DNA sequence and providing confidentiality by preventing human access to an original DNA sequence. A DNA sequencing machine in one embodiment is certified as being compliant with the system function and such certification facilitates acquisition of samples under contract, for example. In another embodiment, the system is provided in a non-embedded arrangement.

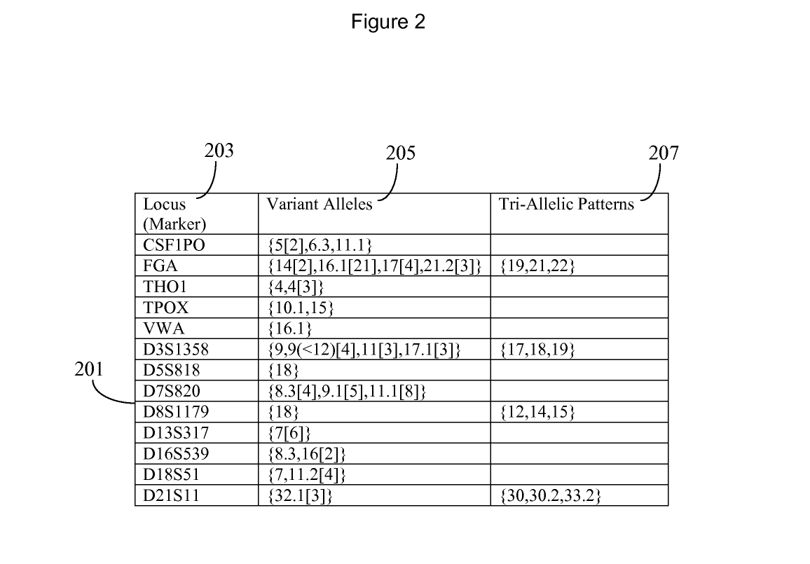

FIG. 2 shows Table 201 presenting a known unencrypted DNA sequence from an individual. In one embodiment a DNA sequencing machine detects particular alleles present in particular markers of a DNA sample (a marker represents a known region on a chromosome). An allele is an alternative form of a gene (one member of a pair) that is located at a specific position on a specific chromosome. These DNA codings determine distinct traits that can be passed from parents to offspring. The process by which alleles are transmitted was discovered by Gregor Mendel and formulated in what is known as Mendel's law of segregation. The example of Table 201 uses the 13 markers identified in column 203 used in the FBI's CODIS (“Combined DNA Index System”) database. However, the system is not limited to these markers.

Genetic markers delineate a region comprised of bands and sub-bands, each of which holds an elemental unit of identifying information comprising an allele. A genetic marker comprises a gene or DNA sequence having a known location on a chromosome. Genetic markers associated with certain diseases can be used to determine whether an individual is at risk for developing an inherited disease. On some specific bands and sub-bands, alleles may vary from a reference value. For example, in marker CSF1PO, the allele designated as 6.3 (corresponding to band 6, sub-band 3) of column 205 varies from the reference norm in 1 out of 11,500 individuals (National Institute of Standards and Technology). A sample is swabbed from an individual and sequenced. The result is a list of variants shown in column 205 from a “normal” base for each marker, as well as certain tri-allelic patterns shown in column 207. DNA variant data may be represented in multiple different ways not just in the string notation form in the table, including as a bitmap, for example. The markers are kept separate as an unknown forensic sample may not contain all 13 markers.

Encoding processor 25 (FIG. 1) advantageously encrypts the DNA variant data using a secure one-way hash function. So the CSF1PO marker

| | |
|---|---|
| CSF1PO | {5[2], 6.3, 11.1} |

is encrypted to:
TWFuIGlzIGRpc3Rpbmd1aXNoZWQsIG5vdCBvbmx5IGJ5IGhpcyByZWFzb24sIG J1DCBieSO0Glz . . .

A marker ID (such as CSF1PO) need not be discernable as long as the markers are encrypted separately, e.g. the 13 encrypted marker variant alleles are in sequential predetermined order. Also, hash key 51 used for the encryption may be kept confidential and secure and maybe unique for an individual person and sealed or destroyed upon termination of use. Thus, no personal medical information is derivable or inferable from encrypted DNA variant data strings, because it is impossible to reconstruct an original marker DNA sequence. A forensic sample is encrypted using the same secure hash key as used in stored encrypted DNA variant data of a population of individuals. If the forensic sample is left by a donor of a known stored sample, the two samples have the same encrypted value, establishing probable cause for more comprehensive testing.

DNA samples are collected from known individuals of a population of interest. The samples are processed by a DNA sequencer 29 (e.g., Siemens OPENGene™). The sequencer contains the encryption system, which applies a secure, one-way hash key function to generate records that are unique to a native DNA sequence, but from which the native DNA sequence cannot be constructed. In this mode of operation, sequencing machine 29 destroys the native sequence before it can be accessed by a human, or excludes access to the DNA sequence thus ensuring the privacy of medical information that could otherwise be derived from the DNA sequence. In one embodiment this process is performed onboard a DNA sequencing machine and in a different embodiment as a separate process on a different device. One embodiment relies on a user destroying the DNA sequence upon production of the hashed sequence. The hashed sequence is tagged with a donor identifier and stored in a database.

A forensic sample is processed in a similar manner to a donor sample. A forensic sample is sequenced and the DNA is hashed using the same hash key. The resulting hashed sequence is compared against a database of donors. A match on one or more markers indicates with high probability that the donor left the forensic sample. The system performs DNA sequencing of forensic material for comparison against hashed DNA sequences of a population that masks genetic characteristics. This enables identification of individuals whilst maintaining their medical privacy and increases the likelihood a population will volunteer samples upon request. In one embodiment a hash key is destroyed and in another embodiment the hash key is secured on a DNA sequencing machine or elsewhere in a repository. The hashed samples are of no use except for identification purposes. Hashed DNA sequences may be kept only as long as necessary improving confidence in the medical information security of the system. Even if a database is stolen, without a hash key it is unintelligible. A new hash key may be generated for individual cases, if desired. The system is usable in circumstances where data containing private information is used for identification, but where the private information content needs to remain private and inaccessible.

A cryptographic hash function is a deterministic procedure that takes an arbitrary block of data and returns a fixed-size bit string, the (cryptographic) hash value, such that an accidental or intentional change to the data changes the hash value. Hash collisions are eliminated using an encryption key large enough to make them for practical purposes non-existent (which does not require a burdensomely large key). In one embodiment, an unencrypted DNA comparison is also performed in addition to the hash comparison to validate an identification. A one-way encryption function is a function that is easy to compute on an input, but hard to invert. Here “easy” and “hard” are to be understood in the sense of computational complexity theory, specifically the theory of polynomial time problems. Not being one-to-one is not considered sufficient of a function for it to be called one-way. In applied contexts, the terms “easy” and “hard” are usually interpreted relative to some specific computing entity; typically “cheap enough for the legitimate users” and “prohibitively expensive for any malicious agents”.

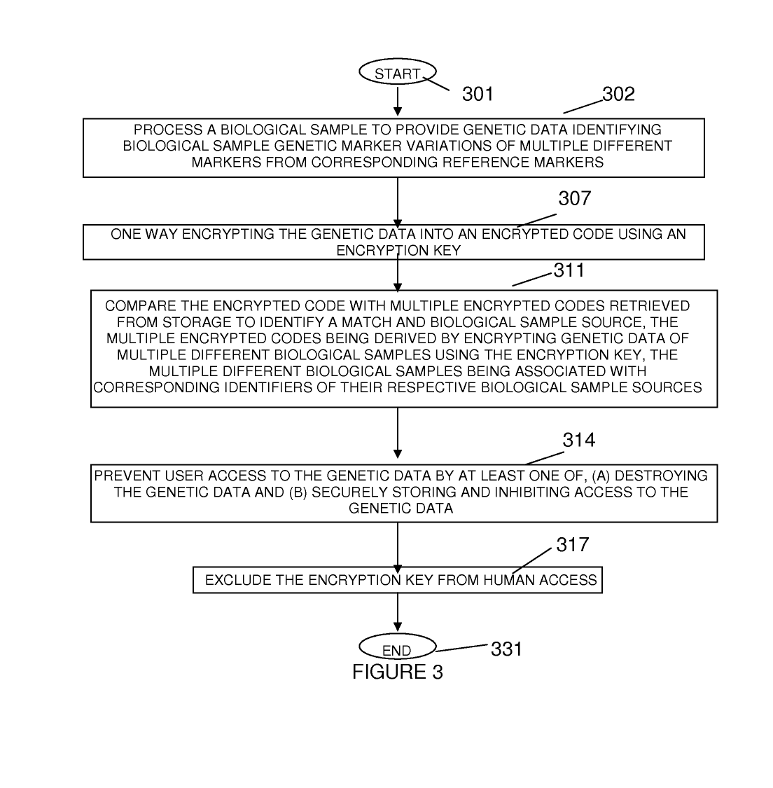

FIG. 3 shows a flowchart of a process performed by system 10 (FIG. 1) for DNA sequence identification that hides personal and medical characteristics. In step 302 following the start at step 301, DNA sequencer 29 processes a biological sample to provide genetic data identifying biological sample genetic marker variations of multiple different markers from corresponding reference markers. The genetic data identifies a first set of individual markers of the multiple different markers and excludes identification of a different second set of individual markers of the multiple different markers. Further, the genetic data identifies individual markers of the multiple different markers in response to order of genetic data of markers. In step 307, encryption processor 25 one way encrypts the genetic data into an encrypted code using an encryption key. In one embodiment, the encrypted code is an irreversible encrypted code and the one way encryption uses a hash function and the encryption key is a hash key.

Comparator 27 in step 311 compares the encrypted code with multiple encrypted codes retrieved from storage to identify a match and biological sample source. The multiple encrypted codes are derived by encrypting genetic data of multiple different biological samples using the encryption key. The multiple different biological samples are associated with corresponding identifiers of their respective biological sample sources. In step 314 encryption processor 25 prevents user access to the genetic data by at least one of, (a) destroying the genetic data and (b) securely storing and inhibiting access to the genetic data. Encryption processor 25 in step 317 excludes the encryption key from human access. The one-way nature of the encryption algorithm prevents sensitive biological data from being acquired even with access to the encryption key. The key only enables determination of a genetic match or non-match. The system provides a unique personal identifier that is derived from the unique genetic makeup of an individual. Key destruction prevents sharing identity with another organization, for example, by preventing matching of an encrypted code to an individual.

In one embodiment, patient data is anonymized for public health reporting, clinical trials, or for transmission of anonymized data to an organization. Patient data using the encrypted code may be uniquely identified for individual patients without revealing patient identity. In a drug trial, for example, a patient taking a certain drug is linked using the encrypted code to a series of observations about that person (i.e., potential side effects observed). A unique encryption key is created and used to generate identifiers for trial participants and a DNA sample from an individual cannot be matched to a study participant without that encryption key. Furthermore, the key may be destroyed as soon as the identifiers have been created or after the study providing an enhanced level of privacy protection beyond the masking of the individual biological traits. The process of FIG. 3 terminates at step 331.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of the FIGS. 1-3 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system creates unique personal identifiers by irreversibly encoding data representing DNA level variants of a human individual within genetic markers and the personal identifiers advantageously provide no personal, health-related biological information. Further, the processes and applications may, in alternative embodiments, be located on one or more (e.g., distributed) processing devices on a network linking the units of FIG. 1. Any of the functions and steps provided in FIGS. 1-3 may be implemented in hardware, software or a combination of both. No claim element herein is to be construed under the provisions of 35 U.S.C. 112, sixth paragraph, unless the element is expressly recited using the phrase “means for.”

What is claimed is:

1. A system for DNA sequence identification hiding personal and medical characteristics, comprising:
a DNA sequencer for processing a biological sample to provide genetic data identifying biological sample genetic marker variations of a plurality of different markers from corresponding reference markers;
an encoding processor for one way encrypting said genetic data into an encrypted code using an encryption key; and
a comparator for comparing said encrypted code with a plurality of encrypted codes retrieved from storage to identify a match and biological sample source, said plurality of encrypted codes being derived by encrypting genetic data of a plurality of different biological samples using said encryption key, said plurality of different biological samples being associated with corresponding identifiers of their respective biological sample sources.

2. A system according to claim 1, wherein
said one way encrypting uses a hash function and said encryption key is a hash key.

3. A system according to claim 1, wherein
said genetic data identifies a first set of individual markers of said plurality of different markers.

4. A system according to claim 3, wherein
said genetic data excludes identification of a different second set of individual markers of said plurality of different markers.

5. A system according to claim 4, wherein
said genetic data identifies individual markers of said plurality of different markers in response to order of genetic data of markers.

6. A system according to claim 1, wherein
said DNA sequencer and said encoding processor are incorporated in a DNA sequencer machine and said encoding processor destroys said genetic data in response to the one way encryption of said genetic data.

7. A system according to claim 1, wherein
said DNA sequencer and said encoding processor are incorporated in a DNA sequencer machine and said encoding processor prevents user access to said genetic data.

8. A system according to claim 1, wherein
said encryption key is excluded from human access.

9. A system according to claim 1, wherein
said encrypted code is an irreversible encrypted code.

10. A DNA sequencing apparatus for generating DNA based identifiers and hiding personal medical characteristics, comprising:
a DNA sequencer for processing a biological sample to provide genetic data identifying biological sample genetic marker variations of a plurality of different markers from corresponding reference markers;
an encoding processor for one way encrypting said genetic data into an encrypted code using an encryption key and prevents user access to said genetic data; and
a comparator for comparing said encrypted code with a plurality of encrypted codes retrieved from storage to identify a match and biological sample source, said plurality of encrypted codes being derived by encrypting genetic data of a plurality of different biological samples using said encryption key, said plurality of different biological samples being associated with corresponding identifiers of their respective biological sample sources.

11. A system according to claim 10, wherein
said encoding processor prevents user access to said genetic data by destroying said genetic data in response to the one way encryption of said genetic data.

12. A method for DNA sequence identification hiding personal and medical characteristics, comprising the steps of:
processing a biological sample to provide genetic data identifying biological sample genetic marker variations of a plurality of different markers from corresponding reference markers;
one way encrypting said genetic data into an encrypted code using an encryption key; and
comparing said encrypted code with a plurality of encrypted codes retrieved from storage to identify a match and biological sample source, said plurality of encrypted codes being derived by encrypting genetic data of a plurality of different biological samples using said encryption key, said plurality of different biological samples being associated with corresponding identifiers of their respective biological sample sources.

13. A method according to claim 12, wherein
said one way encrypting uses a hash function and said encryption key is a hash key.

14. A method according to claim 12, wherein
said genetic data identifies individual markers of said plurality of different markers.

15. A method according to claim 12, wherein
said genetic data excludes identification of individual markers of said plurality of different markers.

16. A method according to claim 15, wherein
said genetic data identifies individual markers of said plurality of different markers in response to order of genetic data of markers.

17. A method according to claim 1, including the step of
preventing user access to said genetic data by at least one of, (a) destroying said genetic data and (b) securely storing and inhibiting access to said genetic data.

18. A method according to claim 12, wherein
said encryption key is excluded from human access.

19. A method according to claim 12, wherein
said encrypted code is an irreversible encrypted code.
